(19) United States
(12) Patent Application Publication
(10) Pub. No.: US 2018/0118547 A1
(43) Pub. Date: May 3, 2018

(54) Product Dispensing Box and Bottle

(71) Applicant: Hatchbeauty Products, LLC, Los Angeles, CA (US)

(72) Inventor: Ben Bennett, Los Angeles, CA (US)

(21) Appl. No.: 15/803,647

(22) Filed: Nov. 3, 2017

Related U.S. Application Data
(60) Provisional application No. 62/417,041, filed on Nov. 3, 2016.

(51) Int. Cl. B67D 1/00; B65D 47/20; B65D 47/12; B65D 77/06

(52) U.S. Cl. CPC B67D 1/0004; B67D 1/0082; B65D 77/065; B65D 47/12; B65D 47/20

(57) ABSTRACT

A product dispensing box and bottle comprising a gusseted bladder with in a box, spigot with an extended spigot that has a cap, and a product delivery mechanism that pushes thick products out of the bladder and spigot. A container that has a label, with an overshell and a base that closely fits around the container, the overshell having an opening and a locking mechanism for the base, so that when the base and overshell are placed around the container and locked together, the label on the container is visible through the overshell opening.

### CROSS-REFERENCE TO RELATED APPLICATION

This patent application claims the benefit of U.S. Provisional Patent Application Ser. No. 62/417,041, entitled “Product Dispensing Box and Bottle” filed Nov. 3, 2016, which application is incorporated in its entirety here by this reference.

### TECHNICAL FIELD

This invention relates to an apparatus for dispensing liquids, and their method of use].

### SUMMARY

There are four packaging elements that work together (1) gusseted liquid bladder; (2) liquid bladder dispensing mechanism; (3) spigot funnel top cap; and (4) bottle locking and orienting where personal care or other product is dispensed into a re-useable bottle that the user can continue to fill and re-fill.

Gusseted Liquid Bladder: A gusseted liquid bladder will be placed inside a corrugate box filled with personal care or other product. This bladder would be structured and gusseted. The spigot would be placed where the gusset is to ensure the bladder has more structure and that the spigot will be easy to place so that it can be pulled out of a die-cut hole in the box for use.

Liquid Bladder Dispenser: The liquid bladder would push out product as it gets used—especially for thicker product that does not flow naturally. This way the user does not need to open the box and squeeze the liquid out in order to fill their bottles.

Spigot Funnel Tip+Cap: The spigot attached at the gusset (from above) will have a longer, more tapered spout than a traditional spigot. This would be to help the user be able to target the spigot into the opening of the inner bottle in order to fill. This is a way to help manage spilling or messes. In addition, a small cap would be attached to the spigot that would be placed onto the tip of the spigot. This would catch any product drip after the user is done filling their bottle. The spigot orifice would also allow for thicker product to flow through it.

Bottle Locking+Orienting: There is an inner bottle that holds the liquid/product and an outer shell. The outer shell has a die-cut hole that once slid over the inner bottle reveals a product indicator label and also locks to the inner bottle. This ensures that when the user goes to pick up the bottle, the shell does not slide around and is secure. The shell would slide down and twist and lock. The position in which the die-cut would land would orient to where the product indicator labels are placed (by the user) on the inner bottle.

These and other features, aspects, and advantages of the present invention will become better understood with reference to the following description and appended claims.

### BRIEF DESCRIPTION OF DRAWINGS

FIG. 1 shows an embodiment of the present invention utilizing a gusseted liquid bladder;

FIG. 2 shows another embodiment of the present invention to dispense thicker liquids;

FIG. 3 shows another embodiment of the present invention with a spigot funnel and a cap; and

FIG. 4 shows a sequence of placing a bottle overshell over a bottle and onto a base.

### DETAILED DESCRIPTION OF THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions and sequences may be accomplished by different embodiments that are also intended to be encompassed within the spirit and scope of the invention.

There are four packaging elements that work together (1) gusseted liquid bladder; (2) liquid bladder dispensing mechanism; (3) spigot funnel tip and cap; and (4) bottle locking and orienting where personal care or other product is dispensed into a re-useable bottle that the user can continue to fill and re-fill.

Gusseted Liquid Bladder

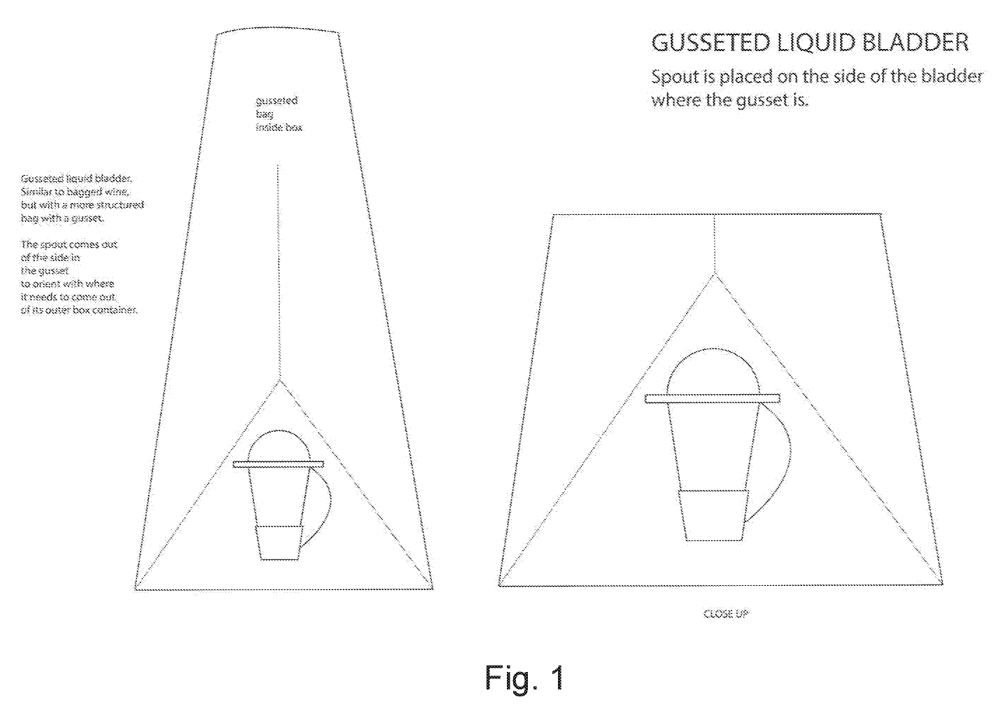

As shown in FIG. 1, a gusseted liquid bladder may be placed inside a corrugate box filled with personal care or other product. This bladder would be structured and gusseted. The spigot would be placed where the gusset is to ensure the bladder has more structure and that the spigot will be easy to place so that it can be pulled out of a die-cut hole in the box for use.

Liquid Bladder Dispenser

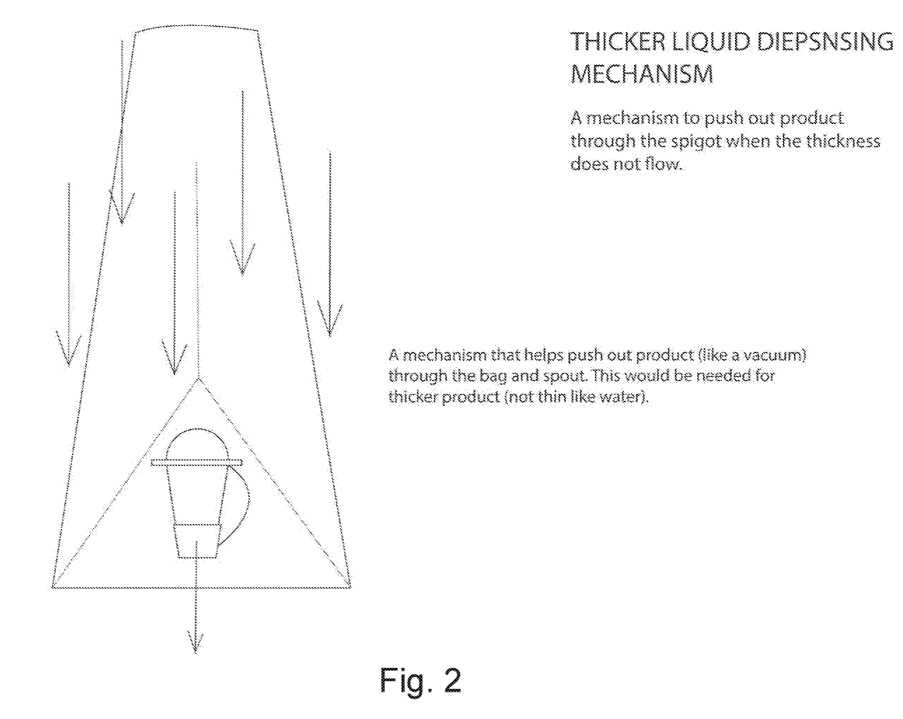

As shown in FIG. 2, the liquid bladder would push out product as it gets used—especially for thicker product that does not flow naturally. This way the user does not need to open the box and squeeze the liquid out in order to fill their bottles.

Spigot Funnel Tip and Cap

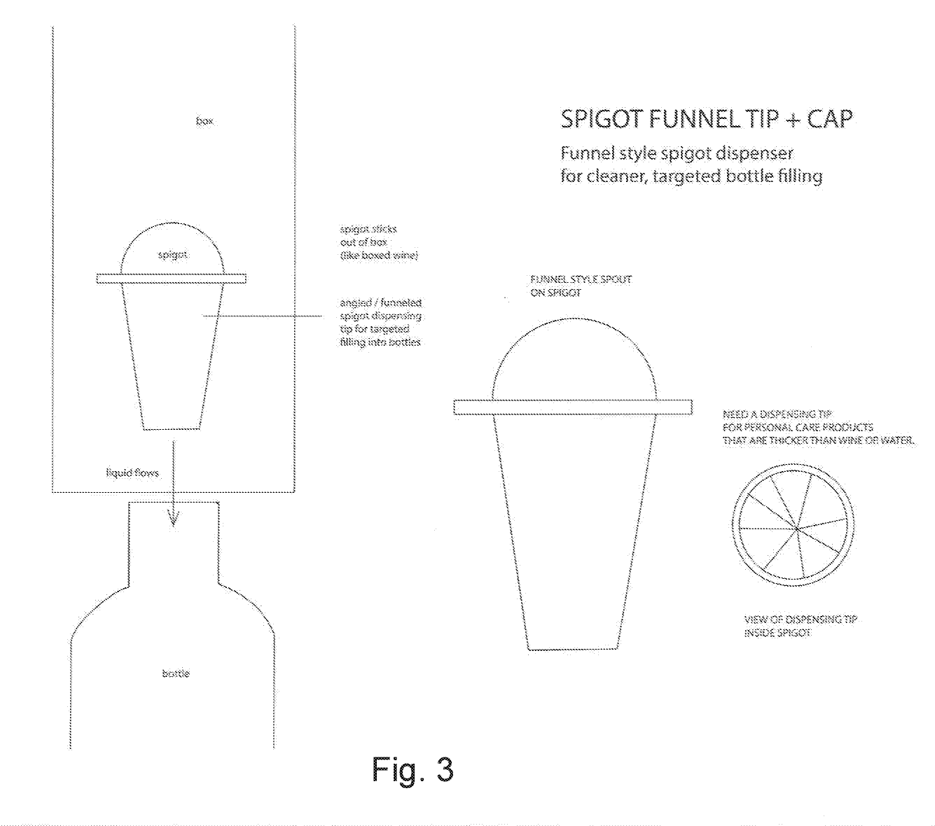

As shown in FIG. 3, the spigot attached at the gusset (from above) will have a longer, more tapered spout than a traditional spigot. This would be to help the user be able to target the spigot into the opening of the inner bottle in order to fill. This is a way to help manage spilling or messes. In addition, a small cap would be attached to the spigot that would be placed onto the tip of the spigot. This would catch any product drip after the user is done filling their bottle. The spigot orifice would also allow for thicker product to flow through it.

Bottle Locking and Orienting

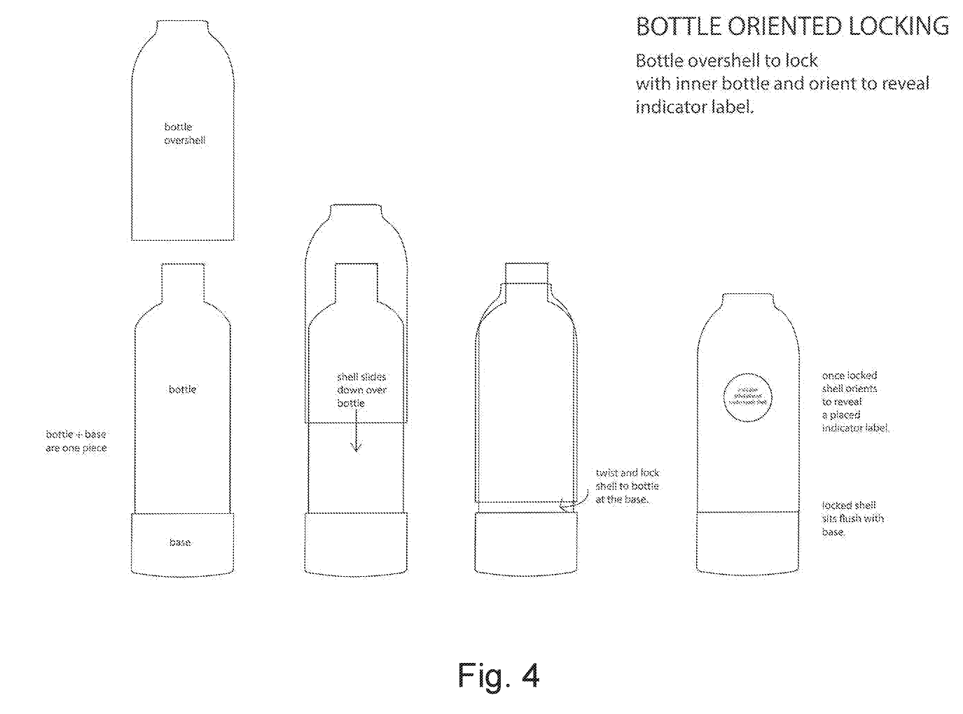

As shown in FIG. 4, there is an inner bottle that holds the liquid/product and an outer shell. The outer shell has a die-cut hole that once slid over the inner bottle reveals a product indicator label and also locks to the inner bottle. This ensures that when the user goes to pick up the bottle, the shell does not slide around and is secure. The shell would slide down and twist and lock. The position in which the die-cut would land would orient to where the product indicator labels are placed (by the user) on the inner bottle.

Objects of the invention include a liquid dispensing apparatus, comprising a gusseted liquid bladder, a spigot with an extended, tapered spout coupled with the gusseted liquid bladder, a mechanism to push thicker product through the spigot; and a cap adapted to removably attach to the tip of the spigot.

Further objects of the invention include a product package comprising a container, comprising a cylindrical portion and a bottom portion, a label on the cylindrical portion of the container, an indexing mechanism on the bottom portion of the container, an overshell configured to closely fit over part of the cylindrical portion of the container, the overshell defining an opening that corresponds to the label on the container, the overshell having a locking mechanism, and a base adapted to closely fit over part of the cylindrical portion of the container, wherein the base comprises an index-accepting mechanism that corresponds to the indexing mechanism on the container, the base further hanging a locking mechanism that corresponds to the locking mechanism on the overshell, so that when the container indexing mechanism is placed in the base index-accepting mechanism, and the overshell is locked to the base, the label on the container is visible through the opening in the overshell.

A further object of this invention is a method of use of a product dispensing box and bottle, comprising filling a gusseted bladder inside a box with liquid product, attaching a spigot and a delivery mechanism to the gusseted bladder, placing a container underneath the spigot, and opening the spigot to allow the liquid product to flow into the container.

What is claimed is:

1. A liquid dispensing apparatus, comprising:
a gusseted liquid bladder;
a spigot with an extended, tapered spout coupled with the gusseted liquid bladder;
a mechanism to push thicker product through the spigot; and
a cap adapted to removably attach to the tip of the spigot.

2. A product package comprising:
a container, comprising a cylindrical portion and a bottom portion;
a label on the cylindrical portion of the container;
an indexing mechanism on the bottom portion of the container;
an overshell configured to closely fit over part of the cylindrical portion of the container, the overshell defining an opening that corresponds to the label on the container, the overshell having a locking mechanism; and
a base adapted to closely fit over part of the cylindrical portion of the container, wherein the base comprises an index-accepting mechanism that corresponds to the indexing mechanism on the container, the base further hanging a locking mechanism that corresponds to the locking mechanism on the overshell, so that when the container indexing mechanism is placed in the base index-accepting mechanism, and the overshell is locked to the base, the label on the container is visible through the opening in the overshell.

3. A method of use of a product dispensing box and bottle, comprising:
a. filling a gusseted bladder inside a box with liquid product;
b. attaching a spigot and a delivery mechanism to the gusseted bladder;
c. placing a container underneath the spigot; and
d. opening the spigot to allow the liquid product to flow into the container.
